(19) United States
(12) Patent Application Publication
(10) Pub. No.: US 2012/0044246 A1
(43) Pub. Date: Feb. 23, 2012

(54) Image Processing Device, Method, and Program

(76) Inventors: Takafumi MORIFUJI, Tokyo (JP); Suguru USHIKI, Tokyo (JP)

(21) Appl. No.: 13/197,457

(22) Filed: Aug. 3, 2011

(30) Foreign Application Priority Data
Aug. 18, 2010 (JP) P2010-182770

(51) Int. Cl. G06T 15/00

(52) U.S. Cl. 345/419

(57) ABSTRACT

Systems and methods are disclosed for processing a stereoscopic image. In one embodiment, an apparatus has an image-reception unit receiving first and second images, an analyzer unit determining a value of at least one parameter of the images, and a comparison unit. The comparison unit may be configured to compare the at least one parameter value to a threshold and to generate a command for displaying the first and second images as a stereoscopic image, if the at least one parameter value meets the threshold.

### PRIORITY APPLICATION

This application claims the benefit of foreign priority to Japanese Patent Application JP 2010-182770, filed in the Japan Patent Office on Aug. 18, 2010, the entire contents of which are hereby incorporated by reference.

### BACKGROUND

The present disclosure relates to an image processing device, method, and program, and more particularly relates to an image processing device, method, and program whereby images unsuitable for stereoscopic display can be detected with good precision.

Heretofore, there have been techniques for displaying stereoscopic images using a pair of image mutually having disparity. Display of a stereoscopic image is performed by observing a left image for the left eye with the left eye of the user and a right image for the right eye with the right eye of the user.

Now, in the event that the disparity of a subject on the images for the left eye and for the right eye is too great in the case of displaying a stereoscopic image, the displayed stereoscopic image will become very hard to view, tiring the eyes of the user who is viewing. Accordingly, there has been proposed a technique for adjusting the disparity of a stereoscopic image in the event that the stereoscopic image has hard to view, so as to convert the stereoscopic image into an image which is not so hard to view (e.g., Japanese Unexamined Patent Application Publication No. 2010-62767).

### SUMMARY

However, there have been cases of image which are not suitable for stereoscopic display including completely different subjects in the images for the left eye and the right eye for example, unmanageable by disparity adjustment alone, so it has been difficult to convert all stereoscopic images into images which are not hard for the user to view. Accordingly, there is demand for a technique to detect images unsuitable for stereoscopic display from images for stereoscopic display, in order to extract and display just those suitable for stereoscopic display.

It has been found to be desirable to enable images unsuitable for stereoscopic display to be detected with good precision.

In light of the above, one aspect of the disclosure relates to an apparatus for processing a stereoscopic image. The apparatus may include an image-reception unit receiving first and second images, an analyzer unit determining a value of at least one parameter of the images, and a comparison unit. The comparison unit may be configured to compare the at least one parameter value to a threshold, and to generate a command for displaying the first and second images as a stereoscopic image, if the at least one parameter value meets the threshold.

Another aspect of the disclosure relates to a stereoscopic image processing method. The method may include receiving first and second images, determining a value of at least one parameter of the images, and comparing the at least one parameter value to a threshold. The method may additionally include generating a command for displaying the first and second images as a stereoscopic image, if the at least one parameter value meets the threshold.

Yet another aspect of the disclosure relates to a non-transitory computer-readable storage medium storing instructions that, when executed by an image-processing device, cause the image-processing device to perform a stereoscopic image processing method. The method may include receiving first and second images, determining a value of at least one parameter of the images, and comparing the at least one parameter value to a threshold. The method may additionally include generating a command for displaying the first and second images as a stereoscopic image, if the at least one parameter value meets the threshold.

According to the above configuration, based on an input image for stereoscopic display made up of a left eye input image and a right eye input image, disparity of the left eye input image and the right eye input image is detected, a predetermined feature amount is generated using the disparity detection results, and whether or not the input image is an image suitable for stereoscopic display is determined, by determining whether or not the feature amount satisfies a predetermined condition, and accordingly, images unsuitable for stereoscopic display can be detected with good precision.

### BRIEF DESCRIPTION OF THE DRAWINGS

FIG. 1 is a diagram illustrating a configuration example of an embodiment of an image processing device to which the present disclosure has been applied;

FIG. 2 is a flowchart for describing stereoscopic display processing;

FIG. 3 is a diagram for describing generating of disparity bidirectional feature amount;

FIG. 4 is a diagram for describing generating of flatness feature amount;

FIG. 5 is a diagram for describing a range of disparity suitable for stereoscopic display;

FIG. 6 is a flowchart for describing stereoscopic display processing;

FIG. 7 is a flowchart for describing stereoscopic display processing;

FIG. 8 is a flowchart for describing stereoscopic display processing;

FIG. 9 is a flowchart for describing stereoscopic display processing; and

FIG. 10 is a block diagram illustrating a configuration example of a computer.

### DETAILED DESCRIPTION OF EMBODIMENTS

Embodiments to which the present disclosure has been applied will be described with reference to the drawings.

### First Embodiment

### Configuration of Image Processing Device

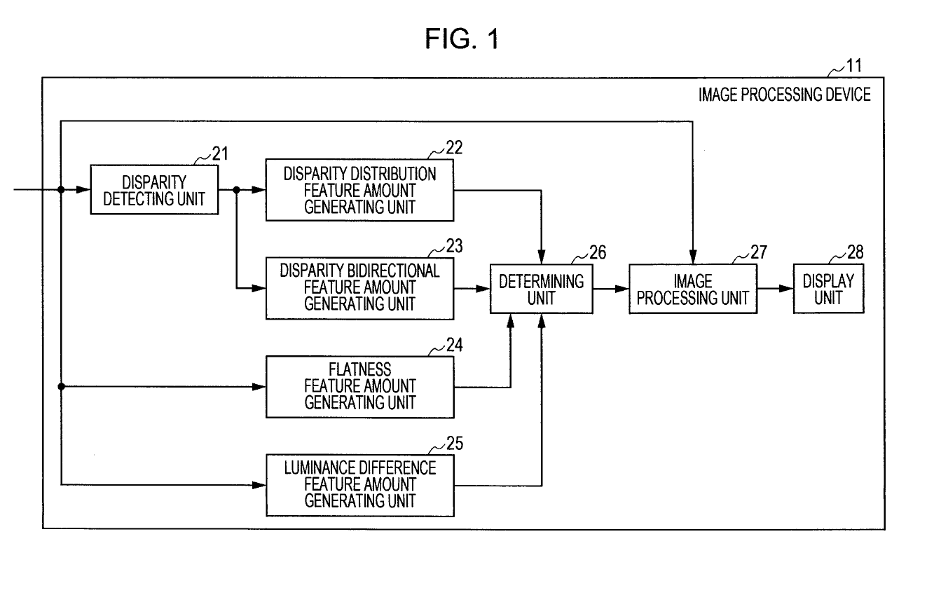

FIG. 1 is a diagram illustrating a configuration example of an embodiment of an image processing device to which the present disclosure has been applied. The image processing device 11 determines whether an input image for stereoscopic display that has been externally input is suitable for stereoscopic display, and depending on the determination results hereof, displays the input image as it is or issues an alert (warning) to the user.

Specifically, with the image processing device 11 an input image wherein the images for the left eye and for the right eye are completely different, an input image wherein a finger of the photographer or strong light is unintentionally in the image for the left eye or for the right eye, an input image where the range of disparity of the subject is to wide, and so forth, are detected as images unsuitable for stereoscopic display.

For example, an input image in which the images for the left eye and for the right eye are completely different is an image in which the disparity of the subject is great enough to exceed the disparity detection range. Also, an input image wherein a finger of the photographer or strong light is unintentionally in the image for the left eye or for the right eye is an image wherein a finger of the photographer or the like is unintentionally in the image for the left eye or for the right eye, or an image where a flare has occurred such that there is a great difference in luminance between the images for the left eye or for the right eye, or the like.

The image processing device 11 extracts multiple feature amounts from the input image (i.e., values for a plurality of parameters of the input image), and compares the input images for the left eye and for the right eye based on the feature amounts, and determines whether or not the input image suitable for stereoscopic display. Note that in the following description, of the pair of images making up the input image for stereoscopic display, the image for the left eye displayed so as to be observed with the left eye of the user will also be referred to as “left eye input image L”, and the image for the right eye displayed so as to be observed with the right eye of the user will also be referred to as “right eye input image R”.

The image processing device 11 is configured of a disparity detecting unit 21, and one or more analyzer units, such as, for example, a disparity distribution feature amount generating unit 22, a disparity bidirectional feature amount generating unit 23, a flatness feature amount generating unit 24, and a luminance difference feature amount generating unit 25. The image processing device 11 may also include a determining unit 26 (e.g., a comparison unit), an image processing unit 27, and a display unit 28.

The disparity detecting unit 21 may receive the left eye input image L and the right eye input image L. The disparity detecting unit 21 may detect the disparity, or displacement, between the left eye input image L and right eye input image R for each pixel, based on the input image that has been input, and supply the detection results thereof to the disparity distribution feature amount generating unit 22 and disparity bidirectional feature amount generating unit 23.

The disparity distribution feature amount generating unit 22 generates disparity distribution feature amount indicating the distribution of the disparity, or displacement, of each subject in the input image, based on the detection results of disparity supplied from the disparity detecting unit 21, and supplies this to the determining unit 26. The disparity bidirectional feature amount generating unit 23 generates disparity bidirectional feature amount indicating the reliability of the disparity detection results in each region of the input image, and supplies this to the determining unit 26.

The flatness feature amount generating unit 24 generates flatness feature amount indicating the degree of flatness, or uniformity, of each region in the input image, based on the input image that has been input, and supplies this to the determining unit 26. Now, the flatness or uniformity of an input image means the smallness in change of pixel values of pixels as to the spatial direction on the input image. The luminance difference feature amount generating unit 25 generates luminance difference feature amount indicating the luminance difference of each region in the left eye input image L and right eye input image R, and supplies this to the determining unit 26.

The determining unit 26 determines whether or not the input image is suitable for stereoscopic display, based on the disparity distribution feature amount, disparity bidirectional feature amount, flatness feature amount, and luminance difference feature amount, supplied from the disparity distribution feature amount generating unit 22, disparity bidirectional feature amount generating unit 23, flatness feature amount generating unit 24, and luminance difference feature amount generating unit 25. The determining unit 26 supplies the determination results of whether or not the input image is suitable for stereoscopic display, to the image processing unit 27.

The image processing unit 27 displays the input image that has been input on the display unit 28, or causes an alert to be displayed on the display unit 28, in accordance with the determination results from the determining unit 26. The display unit 28 performs stereoscopic display of the image supplied from the image processing unit 27 following a predetermined display format.

### Description of Stereoscopic Display Processing

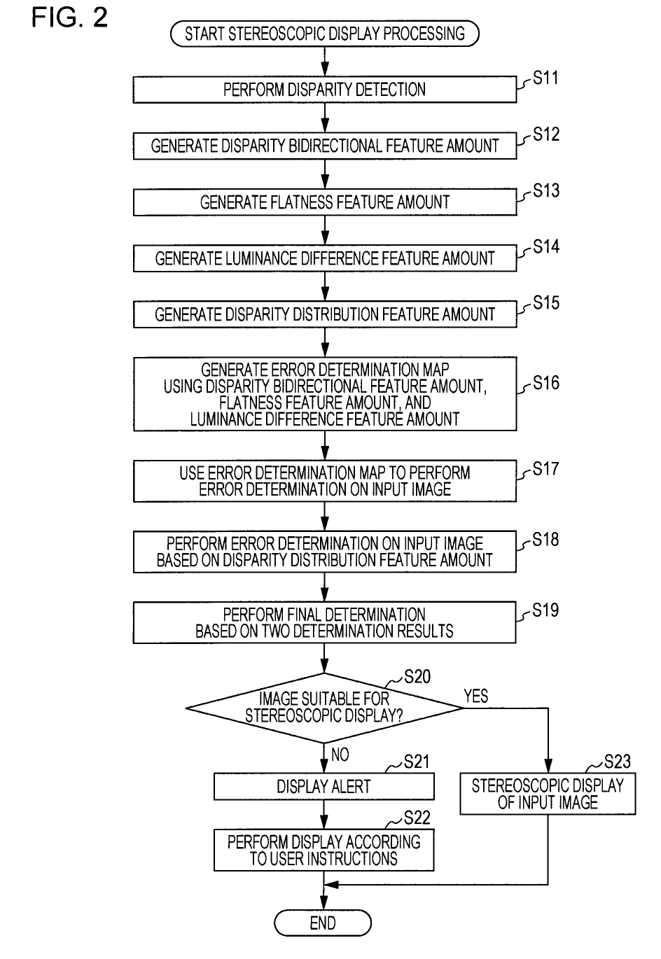

Now, upon the user instructing playing of an input image by operating the image processing device 11, the image processing device 11 starts stereoscopic display processing and performs stereoscopic display of the input image. Hereinafter, description will be made regarding the stereoscopic display processing by the image processing device 11, with reference to the flowchart in FIG. 2.

In step S11, the disparity detecting unit 21 performs disparity detection of the input image based on the input image to be played that has been input, and supplies the detection results thereof to the disparity distribution feature amount generating unit 22 and disparity bidirectional feature amount generating unit 23.

For example, the disparity detecting unit 21 performs DP (Dynamic Programming) matching with the left eye input image L as a reference, so as to detect the disparity of each pixel in the left eye input image L as to the right eye input image R, and generates a disparity map illustrating the detection results. In the same way, the disparity detecting unit 21 detects the disparity of each pixel in the right eye input image R as to the left eye input image L by DP matching with the right eye input image R as a reference, and generates a disparity map illustrating the detection results.

In step S12, the disparity bidirectional feature amount generating unit 23 generates disparity bidirectional feature amount based on the disparity detection results supplied from the disparity detecting unit 21, and supplies this to the determining unit 26.

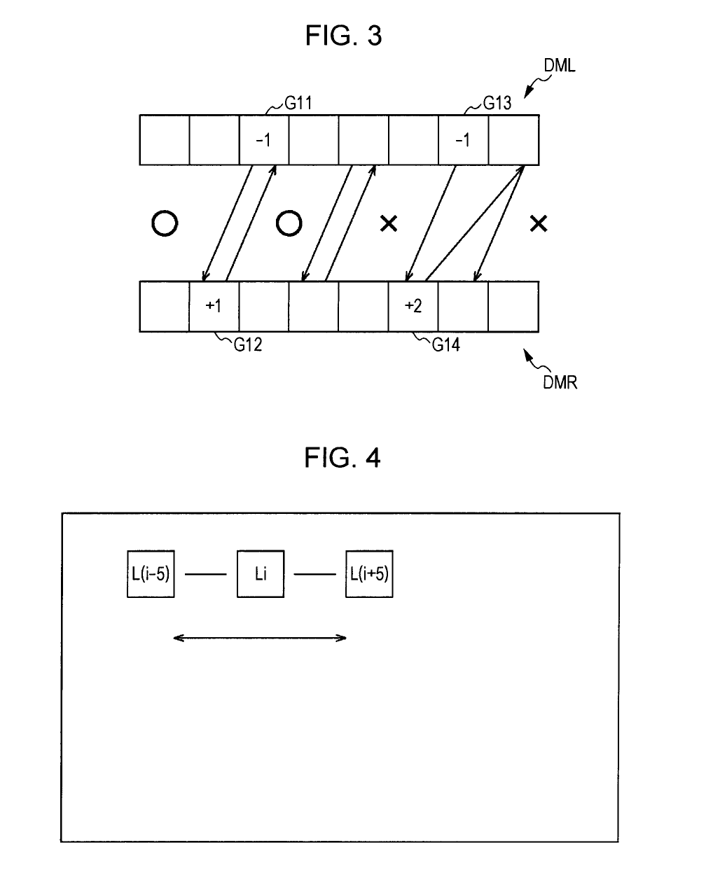

For example, as shown in FIG. 3, the disparity bidirectional feature amount generating unit 23 is provided with a disparity map DML (i.e., a displacement map) indicating the disparity (i.e., displacement) of each of the pixels in the left eye input image L as to the right eye input image R, and a disparity map DMR indicating the disparity (i.e., displacement) of each of the pixels in the right eye input image R as to the left eye input image L.

Note that, in FIG. 3, each square represents one pixel on a disparity map (i.e., a displacement map), and the number within the pixel indicates the disparity. Also, in FIG. 3, we will say that the direction of disparity between the left eye input image L and the right eye input image R is the horizontal direction, and that the right direction in the drawing is the positive direction and the left direction is the negative direction.

Accordingly, the numerical value “−1” within a pixel G11 on the disparity map DML for example, indicates that the disparity in the right eye input image R as viewed from the pixel in the left eye input image L at the same position as that pixel G11 is one pixel in the left direction in the drawing. That is to say, this indicates that the subject displayed at the pixel in the left eye input image L at the same position as the pixel G11 is displayed at the pixel at the same position as the pixel G12 on the disparity map DMR in the right eye input image R.

First, the disparity bidirectional feature amount generating unit 23 takes a certain pixel, in a bidirectional determination map HML indicating the likeliness of detection of disparity between the pixels of the left eye input image L as to the right eye input image R, which is to be obtained, as a pixel of interest.

Based on the disparity or displacement indicated by a pixel on the disparity map DML at the same position of the pixel of interest (hereinafter also referred to as “pixel to be processed”, the disparity bidirectional feature amount generating unit 23 then identifies the pixel on the disparity map DMR corresponding to the pixel to be processed.

Now, a pixel corresponding to the pixel to be processed is a pixel on the disparity map DMR at a position distanced from the pixel at the same position as the pixel to be processed by a distance equal to that the disparity of the pixel to be processed indicates and in that direction. Accordingly, in the event that the pixel G11 on the disparity map DML is the pixel to be processed for example, the pixel corresponding to the pixel G11 is the pixel G12 which is distanced from the pixel at the same position as the pixel G11 on the disparity map DMR in the left direction (negative direction) in the drawing by one pixel.

Upon identifying the pixel on the disparity map DMR corresponding to the pixel to be processed, the disparity bidirectional feature amount generating unit 23 identifies the pixel on the disparity map DML corresponding to that pixel based on the disparity (i.e., displacement) which the identified pixel indicates, and determines whether or not the pixel obtained as the result thereof matches the pixel to be processed. Note that such determination processing will also be referred to as “bidirectional determination.”

Upon performing bidirectional determination, the disparity bidirectional feature amount generating unit 23 decides the pixel value of the pixel of interest based on the determination results thereof. Specifically, in the event that the pixel on the disparity map DML that has been identified as the result of the bidirectional determination is the pixel to be processed, the pixel value of the pixel of interest is set to “1”, and in the event that the pixel on the disparity map DML that has been identified is not the pixel to be processed, the pixel value of the pixel of interest is set to “0”.

The disparity bidirectional feature amount generating unit 23 performs bidirectional determination with the pixels of the bidirectional determination map HML as the pixel of interest, in sequential order, and obtains the pixel values of each pixel of the bidirectional determination map HML, thereby generating the bidirectional determination map HML.

For example, in the event that the pixel to be processed is the pixel G11, the disparity which the pixel G11 indicates is “−1”, so the pixel of the disparity map DMR corresponding to the pixel G11 is the pixel G12. Conversely, the disparity which the pixel G12 indicates is “+1”, so the pixel on the disparity map DML corresponding to the pixel G12 is the pixel G11, and accordingly the pixel corresponding to the pixel G12 matches the pixel to be processed. Accordingly, in the event that the pixel to be processed is the pixel G11, the pixel value of the pixel at the same position as the pixel G11 on the bidirectional determination map HML is “1”.

In this case, the positional relation between the pixel on the left eye input image L at the same position as the pixel G11 and the pixel on the right eye input image R where the same subject as that pixel is displayed, is equal to the positional relation between the pixel on the right eye input image R at the same position on the pixel G12 corresponding to the pixel G11 and the pixel on the left eye input image L where the same subject as that pixel is displayed. This means that the detection results of disparity (i.e., the reliability of the determined displacement) for the pixel G11 are likely.

Conversely, in the event that the pixel to be processed is the pixel G13 on the disparity map DML, the disparity which the pixel G13 indicates is “−1”, so the pixel on the disparity map DMR corresponding to the pixel G13 is the pixel G14. On the other hand, the disparity which the pixel G14 indicates is “+2”, so the pixel on the disparity map DML corresponding to the pixel G14 is the pixel adjacent to the right of the pixel G13 in the drawing, meaning that the pixel corresponding to the pixel G14 does not match the pixel to be processed. Accordingly, in the event that the pixel to be processed is the pixel G13, the pixel value of the pixel at the same position as the pixel G13 on the bidirectional determination map HML is “0”. In this case, it can be said that unlike the case of the pixel G11, the detection result of the disparity of the pixel G13 is unlikely, i.e., that reliability of the determined displacement is low.

Thus, upon generating a bidirectional determination map HML, the disparity bidirectional feature amount generating unit 23 performs processing the same as with the bidirectional determination map HML to generate a bidirectional determination map HMR indicating the likeliness of detection of disparity between the pixels of the right eye input image R and the left eye input image L.

Upon the bidirectional determination map HML and bidirectional determination map HMR being obtained, the disparity bidirectional feature amount generating unit 23 generates a block bidirectional determination map from both of these bidirectional determination maps. That is to say, the disparity bidirectional feature amount generating unit 23 obtains the AND of the bidirectional determination map HML and bidirectional determination map HMR so as to integrate these bidirectional determination maps.

Specifically, the AND of pixel values of pixels at the same positions in the bidirectional determination map HML and bidirectional determination map HMR is obtained, and a value obtained as the result thereof is taken as the pixel value for the pixel in the integrated bidirectional determination maps at the same position as these pixels. In other words, in the event that the pixel values of the pixels at the same position in the bidirectional determination map HML and the bidirectional determination map HMR are both “1”, the pixel value of this pixel in the integrated bidirectional determination map is “1”; otherwise, the pixel value of the pixel in the in the integrated bidirectional determination map is “0”.

Further, the disparity bidirectional feature amount generating unit 23 divides the integrated bidirectional determination map obtained in this way into blocks made up of several pixels, obtains the sum of pixel values of the pixels in each block, and generates a block bidirectional determination map of which the obtained sum is the pixel value of the pixels. That is to say, the pixel value of the pixels of the block bidirectional determination map indicates the sum of pixel values of all pixels belonging to the block on the integrated bidirectional determination map corresponding to that pixel.

The block bidirectional determination map obtained in this way indicates the degree of likeliness of disparity detection results (i.e., the reliability of the determined displacement) at each region of the input image. Upon generating the block bidirectional determination map, the disparity bidirectional feature amount generating unit 23 supplies the generated block bidirectional determination map to the determining unit 26 as bidirectional feature amount.

Returning to the flowchart in FIG. 2, upon the disparity bidirectional feature amount being generated in step S12 the processing advances to step S13.

In step S13, the flatness feature amount generating unit 24 generates flatness feature amount based on the input image that has been input, that is, a value indicating the uniformity of the input image, and supplies this to the determining unit 26.

For example, the flatness feature amount generating unit 24 takes a pixel of interest on the left eye input image L making up the input image as a pixel of interest, as shown in FIG. 4, and takes a block of a predetermined size that is centered on the pixel of interest as a block of interest Li. Also, the flatness feature amount generating unit 24 takes a block in the left eye input image L which is at a position m pixels in the horizontal direction in the drawing from the block of interest (note however, within −5≦m≦5 in the drawing with the right direction as the positive direction), as a block of interest L (i+m). The flatness feature amount generating unit 24 then performs matching between the block of interest Li and the block L (i+m).

Now, in the matching between the block of interest Li and the block of interest L (i+m), the sum of absolute differences of pixel values of pixels at the same position, and so forth, are calculated as evaluation values. That is to say, the flatness feature amount generating unit 24 moves the block of interest Li ±5 pixels at a time in the horizontal direction in the drawing, and in doing so calculates the sum of absolute differences of the block after moving and the block of interest as evaluation values. Note that in FIG. 4, the direction in which the block of interest Li is moved, i.e., the horizontal direction in the drawing, is the direction of disparity of the left eye input image L and the right eye input image R.

In this way, the matching with each block of interest L (i+m) is performed, and upon an evaluation value of the block of interest L (i+m) being obtained (where −5≦m≦5), the flatness feature amount generating unit 24 selects three evaluation values from the obtained evaluation values, in order of smallest values. The flatness feature amount generating unit 24 then obtains the difference between the greatest value and smallest value of the three selected evaluation values, and takes this as the range of the evaluation values. That is to say, the difference between the smallest and third smallest of the evaluation value of each block of interest L (i+m) is calculated as the range of evaluation values.

The flatness feature amount generating unit 24 sequentially takes the pixels on the left eye input image L as the pixel of interest, and obtains the range of evaluation values for each pixel, and thereupon performs threshold determination on these evaluation value ranges, and generates a flatness determination map (i.e., a uniformity determination map).

Specifically, in the event that the range of evaluation values of a certain pixel on the left eye input image L is at or below a predetermined threshold value, the flatness feature amount generating unit 24 takes that pixel as being a flat or uniform value, and sets the pixel value of the pixel on the flatness determination map at the same position as that pixel to “1”. On the other hand, in the event that the range of evaluation values of a certain pixel on the left eye input image L is greater than a predetermined threshold value, the flatness feature amount generating unit 24 sets the pixel value of the pixel on the flatness determination map at the same position as that pixel to “0”, which is a value meaning not flat, or not uniform.

The evaluation values for each pixel in the left eye input image L is the difference between the block of interest center on that pixel and a block near that pixel, so the greater the degree of similarity of these blocks is, the smaller the evaluation value is. Accordingly, the smaller the range of evaluation values is, the flatter or more uniform the picture around the pixel at the center of the block of interest can be said to be.

The pixel value of each pixel in the flatness determination map obtained in this way indicates whether or not around the pixel in the left eye input image L at the same position at that pixel is flat. Note that widening the search range of blocks on the left eye input image L for obtaining the difference as to the block of interest results in the picture of repetitive patterns being detected as well, resulting in determination of whether flat or not being undeterminable with precision, so the search range of the blocks is preferably a range of several pixels.

Next, the flatness feature amount generating unit 24 generates a block flatness determination map from the flatness determination map that has been obtained. Specifically, the flatness feature amount generating unit 24 divides the flatness determination map into blocks made up of several pixels, obtains the sum of pixel values of the pixels in each block, and generates a block flatness determination map of which the obtained sum is the pixel value of the pixels. That is to say, the pixel value of the pixels of the block flatness determination map indicates the sum of pixel values of all pixels belonging to the block on the flatness determination map corresponding to that pixel. The block flatness determination map obtained in this way indicates the degree of flatness or uniformity at each region of the left eye input image L.

Further, the flatness feature amount generating unit 24 generates a block flatness determination map for the right eye input image R, by performing the same processing as the processing for generating the block flatness determination map for the left eye input image L. The flatness feature amount generating unit 24 then supplies the block flatness determination map for the left eye input image L and the block flatness determination map for the right eye input image R to the determining unit 26 as flatness feature amount, i.e., a parameter value indicating the degree of uniformity of the right eye input image R.

Returning to description of the flowchart in FIG. 2, upon the flatness feature amount being generated, the processing advances from step S13 to step S14.

In step S14, the luminance difference feature amount generating unit 25 generates luminance difference feature amount based on the input image that has been input, and supplies this to the determining unit 26.

Specifically, the luminance difference feature amount generating unit 25 obtains the value of absolute differences of the luminance values of pixels at the same position in the left eye input image L and right eye input image R making up the input image, and generates a luminance difference map where the obtained values of absolute differences are the pixel values of the pixels. That is to say, the pixel value of pixels in the luminance difference map indicate the value of absolute differences of luminance value of the pixels in the left eye input image L and right eye input image R at the same position as that pixel.

Next, the luminance difference feature amount generating unit 25 divides the luminance difference map into blocks made up of several pixels, obtains the sum of pixel values of the pixels in each block, and generates a block luminance difference map of which the obtained sum is the pixel value of the pixels. That is to say, the pixel value of the pixels of the block luminance difference map indicates the sum of pixel values of all pixels belonging to the block on the luminance difference map corresponding to that pixel.

The luminance difference feature amount generating unit 25 then supplies the block luminance difference map obtained in this way to the determining unit 26 as luminance difference feature amount. Note that an arrangement may be made wherein the average value of the pixel values of pixels belonging to blocks on the luminance difference map, i.e., the average value of difference in luminance, is taken as the pixel value of pixels on the block luminance difference map.

In step S15, the disparity distribution feature amount generating unit 22 generates disparity distribution feature amount based on the disparity detection results supplied from the disparity detecting unit 21, and supplies this to the determining unit 26.

For example, the disparity distribution feature amount generating unit 22 uses the disparity map DML supplied as disparity detection results to generate a histogram of pixel values of pixels in the disparity map, and takes this as the disparity distribution feature amount. The histogram serving as the disparity distribution feature amount indicates the distribution of disparity or displacement in the input image for each subject. Note that this histogram may be generated using the disparity map DMR, or both the disparity map DML and disparity map DMR.

In step S16, the determining unit 26 generates an error determination map using the determined parameter values: the disparity bidirectional feature amount, flatness feature amount, and luminance difference feature amount, supplied from the disparity bidirectional feature amount generating unit 23, flatness feature amount generating unit 24, and luminance difference feature amount generating unit 25.

Specifically, the determining unit 26 selects a pixel at the same position on the block bidirectional determination map serving as the disparity bidirectional feature amount, the block luminance difference map serving as the luminance difference feature amount, and the block flatness determination map of the left eye input image L and block flatness determination map of the right eye input image R serving as the flatness feature amount, as a pixel to be processed.

Note that at the time of generating the block bidirectional determination map, block luminance difference map, and block flatness determination map, the bidirectional determination map, luminance difference map, and flatness determination map are to be divided into blocks of the same size at the same positional relation. Accordingly, pixel value of each of pixel taken as the pixel to be processed is a value indicating the flatness, luminance difference, and so forth, of the block corresponding to each map.

The determining unit 26 (i.e., comparison unit) determines whether each pixel to be processed in the block bidirectional determination map, block luminance difference map, and block flatness determination map satisfies either of a Condition 1 or a Condition 2 below. In the event that the pixel to be processed satisfies either of Condition 1 or Condition 2, the determining unit 26 determines that the region (block) of the input image corresponding to the pixel to be processed is a region unsuitable for stereoscopic display.

Now, satisfying of Condition 1 is for the following Expression (1) through Expression (3) to hold.

lum_diff(i)>thl (1)

flatL(i)>thf and flatR(i)<thf

or

flatL(i)<thf and flatR(i)>thf (2)

bidir(i)<thb (3)

Note that in Expression (1), lum_diff(i) indicates the pixel value of the pixel to be processed in the block luminance difference map, and th1 indicates a predetermined threshold value.

Also, in Expression (2), flatL(i) and flatR(i) indicate the pixel values of the pixel to be processed in the block flatness determination map for each of the left eye input image L and right eye input image R, and thf indicates a predetermined threshold.

Further, in Expression (3), bidir(i) indicates the pixel value of the pixel to be processed in the block bidirectional determination map, and thb indicates a predetermined threshold.

Accordingly, Condition 1 being satisfied means that the pixel value of the pixel to be processed in the block luminance difference map is greater than the threshold th1, the pixel value of the pixel to be processed in the block flatness determination map for just one of the left eye input image L or right eye input image R is greater than the threshold value thf, and the pixel value of the pixel to be processed in the block bidirectional determination map is smaller than the threshold thb.

Now, the pixel value bidir(i) of the pixel to be processed being smaller than the threshold thb means that in the region of the input image corresponding to the pixel to be processed, there are many pixels regarding which the disparity detection results of the right eye input image R as viewed from the left eye input image L, and the disparity detection results of the left eye input image L as viewed from the right eye input image R do not match. That is to say, the region of the input image corresponding to the pixel to be processed is a region where the detection of disparity (i.e., displacement) is imprecise.

Accordingly, in the event that the above-described Expression (1) and Expression (3) hold, it is highly probable that the regions corresponding to the pixel to be processed in the left eye input image L and the right eye input image R are of different luminance from each other, and are regions where different subject images are included. Also, in the event that Expression (2) holds, just one region of the left eye input image L and right eye input image R corresponding to the pixel to be processed is a flat or uniform region.

Accordingly, in the event that Condition 1 is satisfied, there is a high possibility that the region of the input image corresponding to the pixel to be processed is a region where the left eye input image L and right eye input image R are completely different images, or that a finger of the photographer or strong light is unintentionally in just one of the left eye input image L or right eye input image R. That is to say, in the event that Condition 1 holds, the probability that the region of the input image corresponding to the pixel to be processed is unsuitable for stereoscopic display is high.

Also, the above-described Condition 2 holding means that Expression (1) and Expression (3) hold, and also the following Expression (4) holds.

flatL(i)>thf and flatR(i)>thf (4)

That is to say, Condition 2 holding means that the pixel value of the pixel to be processed in the block luminance difference map is greater than the threshold thl, the pixel value of the pixel to be processed in both block flatness determination maps of the left eye input image L and right eye input image R is greater than the threshold thf, and the pixel value of the pixel to be processed in the block bidirectional determination map is smaller than the threshold thb.

Now, the pixel value of the pixel to be processed in both block flatness determination maps being greater than the threshold thf means that the regions corresponding to the pixel to be processed in the left eye input image L and the right eye input image R are both flat or uniform regions.

That is to say, in the event that Condition 2 is satisfied, the regions of the input image corresponding to the pixel to be processed are likely one of the following. First, there is a high possibility that the regions are images where the left eye input image L and right eye input image R are completely different images, or, second, the finger of the photographer or strong light is unintentionally in both of the left eye input image L and right eye input image R and, accordingly, the regions are of different luminance. In either case, these regions are unsuitable for stereoscopic display.

Note that there are cases wherein images of the same subject are displayed at approximately the same position regions in the left eye input image L and right eye input image R, but both regions are flat, so no disparity can be detected between these regions. In this case, the input image should not be determined to be unsuitable for stereoscopic display, but Expression (1) at least does not hold for such regions, so neither Condition 1 nor Condition 2 are satisfied, and the regions are not determined to be unsuitable for stereoscopic display.

The determining unit 26 performs determination for each pixel in the block bidirectional determination map, block luminance difference map, and block flatness determination map, regarding whether the pixels satisfy either of Condition 1 or Condition 2. The determining unit 26 then generates an error determination map based on the determination results for each of the pixels.

Specifically, in the event that a pixel to be processed satisfies one of Condition 1 or Condition 2, the determining unit 26 sets the pixel value of the error determination map at the same position as that pixel to be processed to the value “1”, indicating that it is unsuitable for stereoscopic display. Also, in the event that a pixel to be processed does not satisfy either of Condition 1 or Condition 2, the determining unit 26 sets the pixel value of the error determination map at the same position as that pixel to be processed to the value “0”, indicating that it is suitable for stereoscopic display. The pixel values of the pixels of the error determination map thus obtained indicate whether or not the region of the input image corresponding to those pixels is suitable for stereoscopic display.

In step S17, the determining unit 26 uses the generated error determination map to perform error determination on the input image, and determines whether the overall input image is an image suitable for stereoscopic display or not.

For example, the determining unit 26 obtains the sum of pixel values of each pixel in the error determination map, and in the event that the obtained sum is at or above a predetermined threshold, determines that the input image is unsuitable for stereoscopic display. The pixel values of the pixels of the error determination map indicate whether or not the region of the input image corresponding to that pixel are suitable for stereoscopic display, so the sum of the pixel values of each of the pixels in the error determination map indicate the degree of suitability of the overall input image as an image for stereoscopic display. That is to say, the greater the sum of the pixel value is, the more unsuitable the input image is for stereoscopic display.

In step S18, the determining unit 26 performs error determination as to the input image, based on the disparity distribution feature amount supplied from the disparity distribution feature amount generating unit 22. That is to say, determination is made regarding whether or not the input image is an image suitable for stereoscopic display.

For example, the determining unit 26 obtains the range of disparity of the subject in the input image based on the histogram supplied as disparity distribution feature amount. Now, the histogram has disparity ranges in the input images as bins, and shows the frequency values of each bin. That is to say, this illustrates the distribution of disparity or displacement in the input image.

The determining unit 26 removes the fringe portions from the disparity distribution shown in the histogram, by an amount of the 2% by area of the outer edges, from the area of the entire distribution, and takes the range from the minimum value to the maximum value in the distribution from which the fringe portions have been removed, as the range of disparity of the subject in the input image.

That is to say, the pixels of the greatest 2% of disparity and the pixels of the smallest 2% of disparity are removed from the group of all pixels of the input image, and the range from the smallest value to the greatest value of disparity in the pixels belonging to the group from which those pixels have been removed are taken as the disparity range.

Further, determination is made regarding whether or not the range of disparity or displacement that has been obtained within a predetermined disparity range which has been set beforehand, and in the event that the range is within the predetermined disparity range, determination is made that the input image is a suitable image for stereoscopic display.

For example, in the event that the disparity range exceeds the predetermined disparity range, there is too much difference in disparity or displacement for each subject, and viewing the input image would tire the user, so such an input image is determined to be an image which is unsuitable for stereoscopic display.

Note that the predetermined disparity range which has been set beforehand is a disparity range in which users can comfortably view the input image, and this disparity range can be obtained beforehand based on the assumed viewing distance from the user to the display screen of the display unit 28, from the size of the display screen of the display unit 28, or the like.

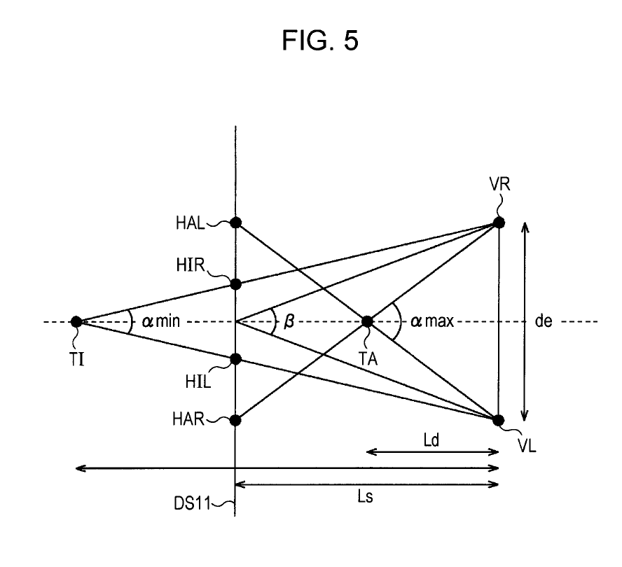

For example, as shown in FIG. 5, we will say that a user is viewing an input image at a position distanced from a display screen DS11 of the display unit 28 where the input image is displayed, by a viewing distance Ls in the horizontal direction in the drawing. Also, we will say that the left and right eyes of the user are situated at viewing point VL and viewing point VR respectively, with the distance from the viewing point VL to the viewing point VR, i.e., the distance between the left and right eyes of the user, being de.

Further, we will refer to the position where the subject with the greatest disparity (i.e., displacement) in the input image localizes, i.e., the point where the stereoscopic image occurs, as point TA, and the display positions of the subject in each of the left eye input image L and right eye input image R, as point HAL and point HAR, respectively. Also, the angle between a line connecting the viewing point VL and the point TA and a line connecting the viewing point VR and the point TA will be referred to as disparity angle αmax.

In the same way, we will refer to the position where the image with the smallest disparity (i.e., displacement) in the input image localizes as point TI, and the display positions of the subject in each of the left eye input image L and right eye input image R, as point HIL and point HIR, respectively. Also, the angle between a line connecting the viewing point VL and the point TI and a line connecting the viewing point VR and the point TI will be referred to as disparity angle αmin.

Further, in the following, with regard to an arbitrary subject in the input image, the disparity angle of the subject will be referred to as α, and the distance in the horizontal direction in the drawing from the localization position of the subject to the viewing position VL (or viewing point VR) as Ld. For example, in the event that the localization position of the subject is at the point TA, the disparity angle α is αmax.

In the event of the user viewing an input image on the display screen DS11 under the viewing conditions shown in FIG. 5, generally, the following Expression (5) has to hold for the user to comfortably view the input image.

|α−β|≦1°=(Π/180) (5)

That is to say, the disparity angle α of each subject in the input image has to satisfy β−(Π/180)≦α≦β+(Π/180). From Expression (5), we can see that the disparity angle αmin is β−(Π/180), and that the disparity angle αmax is β+(Π/180).

Also, in order for Expression (5) to hold, the distance Ld from the user to the localization position of the subject can be obtained as follows.

That is to say, the distance Ld from the user to the localization position of the subject is obtained from the disparity angle α and the distance de between the left and right eyes of the user, by the following Expression (6).

Ld=de/2 tan(α/2) (6)

From this Expression (6), we can see that the user can view the input image comfortably if the following Expression (7) holds.

de/2 tan(αmax/2)≦Ld≦de/2 tan(αmin/2) (7)

Now, the disparity angle αmin=β−(Π/180), and the disparity angle αmax=β+(Π/180). Also, the angle of view β for calculating the disparity angle αmin and the disparity angle αmax is determined from the viewing distance Ls and the distance de between the left and right eyes of the user. That is to say, in FIG. 5, Expression (8) holds from the relation between the viewing distance Ls and the angle of view β, so this Expression (8) can be modified into Expression (9), whereby the angle of view β is obtained.

(de/2)/Ls=tan(β/2) (8)

β=2 tan⁻¹(de/2Ls) (9)

Thus, if the distance Ld from the user to the localization position of the subject can be found such that the user can comfortably view the input image, the range of disparity of the subject in which the user can comfortably view the input image can be obtained from this distance Ld.

For example, in the event that the display unit 28 is a 46V type display device, and the viewing distance Ls is 1.7 m, the user can comfortably view the input image if the distance Ld from the user to the localization position of each subject is within the range of 0.5 m to 1.5 m. Putting the range of distance Ld into terms of disparity or displacement, this will be a range from around −56 pixels to 55 pixels.

Returning to the description of the flowchart in FIG. 2, in step S18, upon determination being made regarding whether or not the input image is an image suitable for stereoscopic display based on the disparity distribution feature amount, the processing advances to step S19.

In step S19, the determining unit 26 performs the final determination regarding whether or not the input image is an image suitable for stereoscopic display, from the results of determination using the error determination map that has been performed in step S17 and the results of determination based on disparity distribution feature amount that has been performed in step S18. The determining unit 26 then supplies the final determination results whether or not the input image is an image suitable for stereoscopic display to the image processing unit 27.

Specifically, in the event that the results of determination using the error determination map and the results of determination based on the disparity distribution feature amount are both determination results to the effect that the image is suitable for stereoscopic display, determination is made that the image is suitable for stereoscopic display. However, in the event that any one of the results of determination using the error determination map and the results of determination based on the disparity distribution feature amount are determination results to the effect that the image is unsuitable for stereoscopic display, determination is made that the image is unsuitable for stereoscopic display.

In step S20, the image processing unit 27 determines whether or not the determination results from the determining unit 26 are determination results to the effect that the image is suitable for stereoscopic display.

In the event that determination is made in step S20 that the determination results are not to the effect that the image is suitable for stereoscopic display, in step S21 the image processing unit 27 displays an alert on the display unit 28 indicating that the input image which is to be played is not suitable for stereoscopic display.

In step S22, the image processing unit 27 performs display in accordance with user instructions, and the stereoscopic display processing ends.

For example, in the event that an alert is displayed on the display unit 28 and the user operates the image processing device 11 so as to instruct canceling of playing of the input image, the image processing unit 27 does not display the input image on the display unit 28. Also, in the event that an alert is displayed on the display unit 28 and the user operates the image processing device 11 so as to instruct display of the input image as it is, the image processing unit 27 supplies the input image that has been input to the display unit 28 without change, for stereoscopic display to be performed.

Further, for example, an arrangement may be made wherein, in response to user instructions, the image processing unit 27 supplies just one of the left eye input image L or right eye input image R making up the input image that has been input to the display unit 28 so as to be displayed. Now, which of the left eye input image L and right eye input image R to be displayed may be determined based on the block flatness determination map, for example.

Specifically, in the event that the sum of pixel values of each pixel in the block flatness determination map of the left eye input image L is smaller than the sum of pixel values of each pixel in the block flatness determination map of the right eye input image R, the left eye input image L is less flat (i.e., uniform), so the left eye input image L is displayed on the display unit 28. This is because, of the pair of images making up the input image, the flatter, or more uniform, image more likely includes the finger of the photographer or the like, so the image which is not flatter is more suitable for display. Note that in such a case, the image processing unit 27 determines which of the left eye input image L and right eye input image R to display, using the block flatness determination map supplied from the determining unit 26.

Also, an arrangement may be made wherein, in accordance with user instructions, the image processing unit 27 generates a pair of input images for stereoscopic display by 2D/3D conversion using just one of the left eye input image L or right eye input image R, and supplies this to the display unit 28 for display.

Specifically, of the left eye input image L and right eye input image R, the image which is less flat, i.e., the image which has a smaller sum of pixel values of each pixel in the block flatness determination map, is selected. For example, if we say that the left eye input image L has been selected, the image processing unit 27 takes the left eye input image L as the image for the left eye, and generates a new right eye input image R in which the left eye input image L has been shifted by a predetermined distance. The image processing unit 27 supplies the input image made up of the left eye input image L and the newly-generated right eye input image R to the display unit 28 for stereoscopic display.

Note that while a case of using the block flatness determination map has been described as an example of a method for determining which of the left eye input image L and right eye input image R is an image more suitable for display, but besides this, the image which is more suitable for display may be determined using the bidirectional determination map HML and bidirectional determination map HMR.

Also, an error determination map generated with the left eye input image L as a reference and an error determination map generated with the right eye input image R as a reference may be used to determine which image is more suitable for display. In this case, for example, the image of the left eye input image L and right eye input image R which has the smaller sum of pixel values of the pixels in the error determination map is selected as the image for suitable for display.

On the other hand, in the event that determination is made in step S20 that the determination results indicate that the image is suitable for stereoscopic display, in step S23, the image processing unit 27 supplies the input image that has been input to the display unit 28 for stereoscopic display, and the stereoscopic display processing ends.

As described above, the image processing device 11 extracts the disparity distribution feature amount, flatness feature amount, and luminance difference feature amount from the input image, and determines whether or not the input image is an image suitable for stereoscopic display, according to whether or not these feature amounts satisfy certain conditions. Thus, whether or not input images are suitable for stereoscopic display is determined using feature amounts extracted from the input images, so images unsuitable for stereoscopic display can be detected with good precision.

Also, in the event that the input image is unsuitable for stereoscopic display, display is performed in accordance with user instructions, thereby reducing the chance of the user viewing pictures unsuitable for stereoscopic display, thereby alleviating fatigue of the eyes of the user and discomfort.

### Second Embodiment

### Description of Stereoscopic Display Processing

Note that while description has made above that threshold determination is performed for each feature amount, whereby determination is made regarding whether or not each feature amount satisfies predetermined conditions, and determination is made regarding whether the input image is suitable for stereoscopic display based on the determination results, an arrangement may be made wherein vectors made up of the feature amounts are used to determine whether or not the feature amounts satisfy the predetermined conditions.

In such a case, multiple images suitable for stereoscopic display and images unsuitable for stereoscopic display for example are prepared, with the sample images being divided into multiple blocks, and the feature vectors of each of the blocks being obtained.

Now, a feature vector is a vector obtained by arraying the pixel values of pixels corresponding to a block to be processed in the block bidirectional determination map, block luminance difference map, block flatness determination map for the left eye input image L, and block flatness determination map for the right eye input image R. That is to say, this is a four-dimensional vector having the pixel values of the pixel at the same position in each map as elements. Also, more particularly, labeling is performed beforehand for each block of the sample images, regarding whether or not that block is suitable for stereoscopic display.

Upon the feature vectors of each of the blocks of the multiple sample images being obtained, clustering is performed as to these feature vectors. That is to say, the multiple feature vectors are separated into a cluster of feature vectors of blocks suitable for stereoscopic display and a cluster of feature vectors of blocks unsuitable for stereoscopic display. A representative value is obtained for the feature vectors belonging to each of the two clusters. For example, the representatively value is the center-of-gravity value of the feature vectors belonging to the cluster, or the like.

The determining unit 26 has recorded, beforehand, representative values of clusters made up of feature vectors of blocks suitable for stereoscopic display (hereinafter, referred to as “correct representative value”), and representative values of clusters made up of feature vectors of blocks unsuitable for stereoscopic display (hereinafter, referred to as “error representative value”). How close a feature vector of a block of the input image to be determined is to one of the correct representative value and error representative value determines whether or not it is suitable for stereoscopic display.

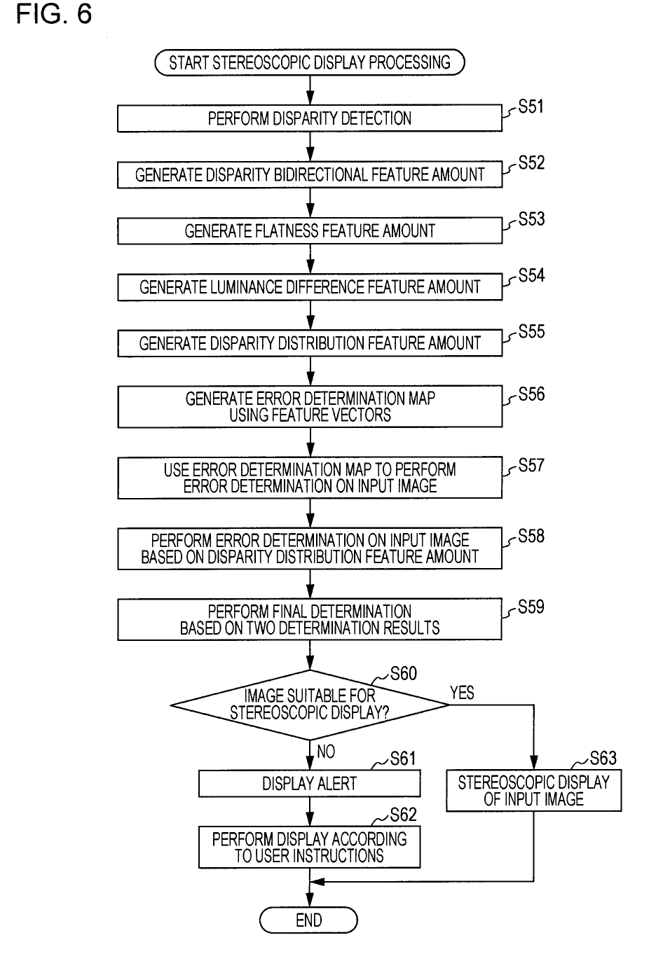

In the event that determination using correct representative values and error representative values is to be performed as described above, the image processing device 11 performs the stereoscopic display processing shown in FIG. 6. The stereoscopic display processing by the image processing device 11 will now be described with reference to the flowchart in FIG. 6.

Note that the processing of step S51 through step S55 is the same as the processing in step S11 through step S15 in FIG. 2, and accordingly description thereof will be omitted.

Upon the processing in step S55 being performed, the determining unit 26 is supplied with the disparity bidirectional feature amount, luminance difference feature amount, and flatness feature amount. That is to say, a block bidirectional determination map, block luminance difference map, block flatness determination map for the left eye input image L, and block flatness determination map for the right eye input image R, are supplied.

In step S56, the determining unit 26 uses the feature vectors obtained from the disparity bidirectional feature amount, luminance difference feature amount, and flatness feature amount, to generate an error determination map.

The determining unit 26 for example takes a pixel at the same position on the block bidirectional determination map, block luminance difference map, block flatness determination map for the left eye input image L, and block flatness determination map for the right eye input image R, as the pixel to be processed, and arrays the pixel values of the pixel to be processed so as to be a feature vector. The determining unit 26 then obtains the Euclidian distance between the feature vector and each of the correct representative values and error representative values recorded beforehand.

Further, in the event that the distance between the feature vector of the pixel to be processed and a correct representative value is closer than the distance between the feature vector and an error representative value, the determining unit 26 takes the region of the input image corresponding to the pixel to be processed as being suitable for stereoscopic display. Also, in the event that the distance between the feature vector and an error representative value is closer than the distance between the feature vector of the pixel to be processed and a correct representative value, the determining unit 26 takes the region of the input image corresponding to the pixel to be processed as being unsuitable for stereoscopic display.

The determining unit 26 performs determination for each pixel of the block bidirectional determination map, block luminance difference map, and block flatness determination maps, regarding whether or not the region of input image corresponding to those pixels is suitable for stereoscopic display. The determining unit 26 then generates an error determination map based on the determination results for each pixel.

Specifically, with regard to the pixel to be processed, in the event that the distance from the feature vector to the correct representative value is shorter than to the error representative value, the determining unit 26 sets the pixel value of the pixel on the error determination map at the same position as that pixel to be processed to the value “0”, indicating that this is suitable for stereoscopic display. Also, with regard to the pixel to be processed, in the event that the distance from the feature vector to the error representative value is shorter than to the correct representative value, the determining unit 26 sets the pixel value of the pixel on the error determination map at the same position as that pixel to be processed to the value “1”, indicating that this is unsuitable for stereoscopic display.

In step S57, the determining unit 26 uses the generated error determination map to perform error determination as to the input image, and determines whether or not the input image is overall an image suitable for stereoscopic display.

For example, the determining unit 26 obtains the sum of pixel values of each of the pixels in the error determination map, and in the event that the obtained sum is equal to or greater than a preset threshold, determines that the input image is unsuitable for stereoscopic display. The pixel values of each of the pixels in the error determination map indicate whether the region of the input image corresponding to that pixel is suitable for stereoscopic display, so the sum of pixel values of each of the pixels in the error determination map indicate the degree of suitability of the overall input image as an image for stereoscopic display. That is to say, the greater the sum of pixel values is, the less suitable the input image is for stereoscopic display.

Upon error determination being performed as to the overall input image, thereafter the processing of step S58 through step S63 is performed and the stereoscopic display processing ends, but this processing is the same as the processing of step S18 through S23 in FIG. 2, so description thereof will be omitted.

Thus, the image processing device 11 determines whether or not each region of the input image is suitable for stereoscopic display, based on the distance between feature vectors and correct representative values and error representative values. Thus, performing determination of whether suitable for stereoscopic display or not by comparing feature vectors with correct representative values and error representative values enables determination processing to be performed easily and speedily.

### Modification 1

Description of Stereoscopic Display Processing

Now, while description has been made above that an alert is displayed in the event that the input image is unsuitable for stereoscopic display, but an arrangement may be made wherein an alert is not displayed, the input image is subjected to signal processing as appropriate so as to be an image suitable for stereoscopic display, with the image obtained as the result thereof being displayed.

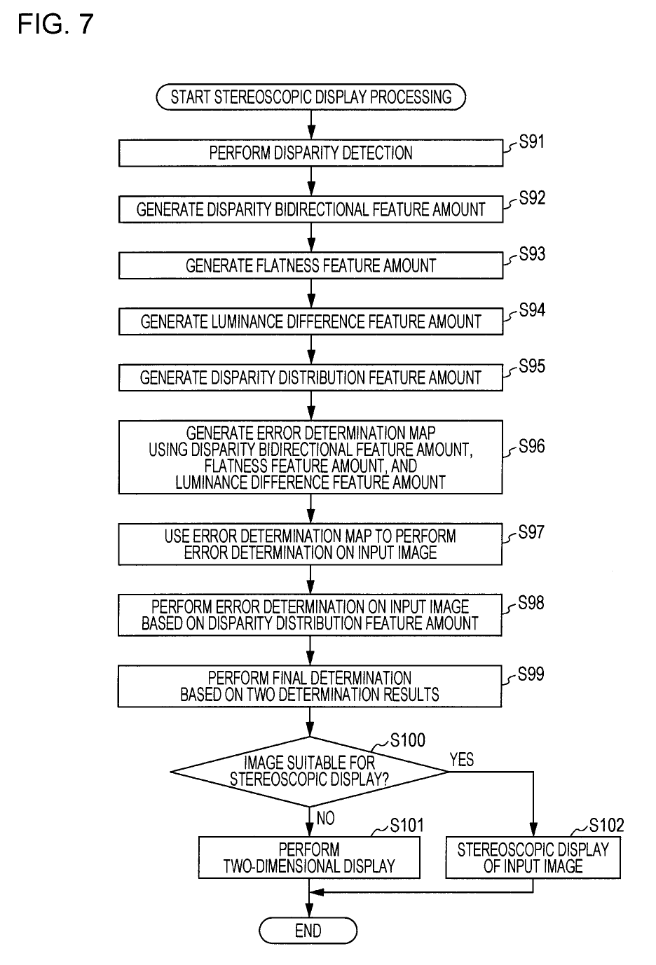

For example, an arrangement may be made such that, in the event that determination is made that the input image is unsuitable for stereoscopic display, a two-dimensional image is displayed instead of a three-dimensional image. In such a case, the stereoscopic display processing shown in FIG. 7, for example, is performed.

The stereoscopic display processing by the image processing device 11 will now be described with reference to the flowchart in FIG. 7. Note that the processing of step S91 through step S100 is the same as the processing in step S11 through step S20 in FIG. 2, and accordingly description thereof will be omitted.

Note however, in step S99, that in the event that determination results are supplied from the determining unit 26 to the image processing unit 27 to the effect that the image is unsuitable for stereoscopic display, a block flatness determination map is also supplied along with the determination results.

In the event that determination is made in step S100 that the input image is unsuitable for stereoscopic display, in step S101, the image processing unit 27 supplies one of the left eye input image L and right eye input image R making up the input image that has been input to the display unit 28, so as to be displayed two-dimensionally. The display unit 28 performs two-dimensional display of the image supplied from the image processing unit 27, and the stereoscopic display processing ends. That is to say, a two-dimensional input image is displayed on the display unit 28.

For example, in the event that determination is made in step S100 of being unsuitable for stereoscopic display, the image processing unit 27 identifies, of the left eye input image L and the right eye input image R, the image with a smaller sum of pixel values of each pixel in the block flatness determination map, as being the image which is less flat.

The image processing unit 27 then supplies, of the input left eye input image L and right eye input image R, the image which is less flat, to the display unit 28 for display. As described above, the flatter image of the left eye input image L and right eye input image R may have a finger of the photographer or the like in the image, so displaying the image which is less flat on the display unit 28 allows a better-looking image to be presented.

Note that an arrangement may be made wherein which of the left eye input image L and right eye input image R to display is selected using the bidirectional determination map or error determination map, rather than the block flatness determination map.

Conversely, in the event that determination is made in step S100 that the input image is suitable for stereoscopic display, in step S102 the image processing unit 27 supplies the input image that has been input to the display unit 28 for stereoscopic display, and the stereoscopic display processing ends.

Thus, in the event that determination is made that the input image is unsuitable for stereoscopic display, the image processing device 11 performs two-dimensional display of one of the left eye input image L and right eye input image R making up the input image. Accordingly, the user can be presented with the input image, while preventing tiring of the eyes of the user due to displaying an image unsuitable for stereoscopic display.

### Modification 2

Description of Stereoscopic Display Processing

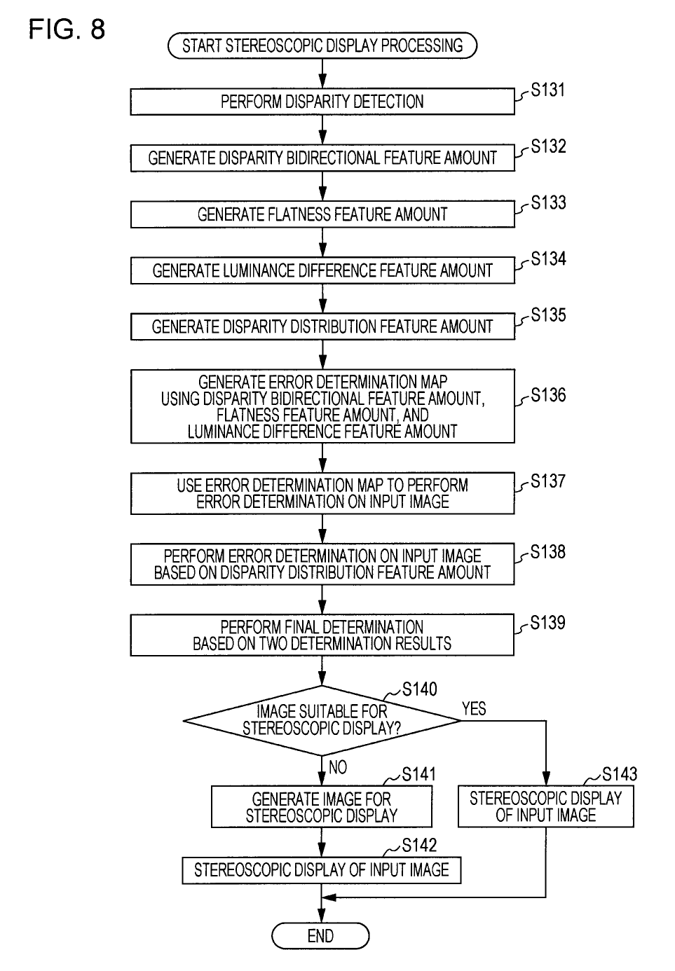

Also, in the event that determination is made that the input image is unsuitable for stereoscopic display, an arrangement may be made wherein a pair of images having a disparity or displacement that correspond to each other is generated from one of the left eye input image L and right eye input image R making up the input image, so as to perform stereoscopic display thereof. In such a case, the stereoscopic display processing shown in FIG. 8 is performed.

The stereoscopic display processing by the image processing device 11 will now be described with reference to the flowchart in FIG. 8. Note that the processing of step S131 through step S140 is the same as the processing in step S11 through step S20 in FIG. 2, and accordingly description thereof will be omitted.

Note however, in step S139, that in the event that determination results are supplied from the determining unit 26 to the image processing unit 27 to the effect that the image is unsuitable for stereoscopic display, a block flatness determination map is also supplied along with the determination results.

In the event that determination is made in step S140 that the input image is unsuitable for stereoscopic display, in step S141 the image processing unit 27 uses one of the left eye input image L and right eye input image R making up the input image that has been input, to generate a stereoscopic display image.

That is to say, the image processing unit 27 uses, of the left eye input image L and the right eye input image R, the image with a smaller sum of pixel values of each pixel in the block flatness determination map, as being the image which is less flat, or less uniform. The image processing unit 27 then uses of the left eye input image L and the right eye input image R, the image which is less flat or uniform, to generate a pair of images having disparity as to each other.

For example, if we way that the left eye input image L is the image which is less flat or uniform, the image processing unit 27 takes the left eye input image L as the image for the left eye, and also generates an image obtained by shifting the left eye input image L in a predetermined direction by a predetermined distance as a new right eye input image R. The image processing unit 27 then supplies an input image made up of the left eye input image L and the newly-generated right eye input image R to the display unit 28.

Note that an arrangement may be made wherein which of the left eye input image L and right eye input image R to use for stereoscopic display of the image is selected using the bidirectional determination map or error determination map, rather than the block flatness determination map.

In step S142, the display unit 28 performs stereoscopic display of the input image based on the left eye input image L and right eye input image R supplied from the image processing unit 27, and the stereoscopic display processing ends.

Conversely, in the event that determination is made in step S140 that the input image is suitable for stereoscopic display, in step S143 the image processing unit 27 supplies the input image that has been input to the display unit 28 for stereoscopic display, and the stereoscopic display processing ends.

Thus, in the event that determination is made that the input image is unsuitable for stereoscopic display, the image processing device 11 uses one of the left eye input image L and right eye input image R making up the input image to generate the other image anew, and performs stereoscopic display of the input image based on the obtained pair of images. Accordingly, the user can be presented with an image more suitable for stereoscopic display, while alleviating tiring of the eyes of the user.

### Modification 3

Description of Stereoscopic Display Processing

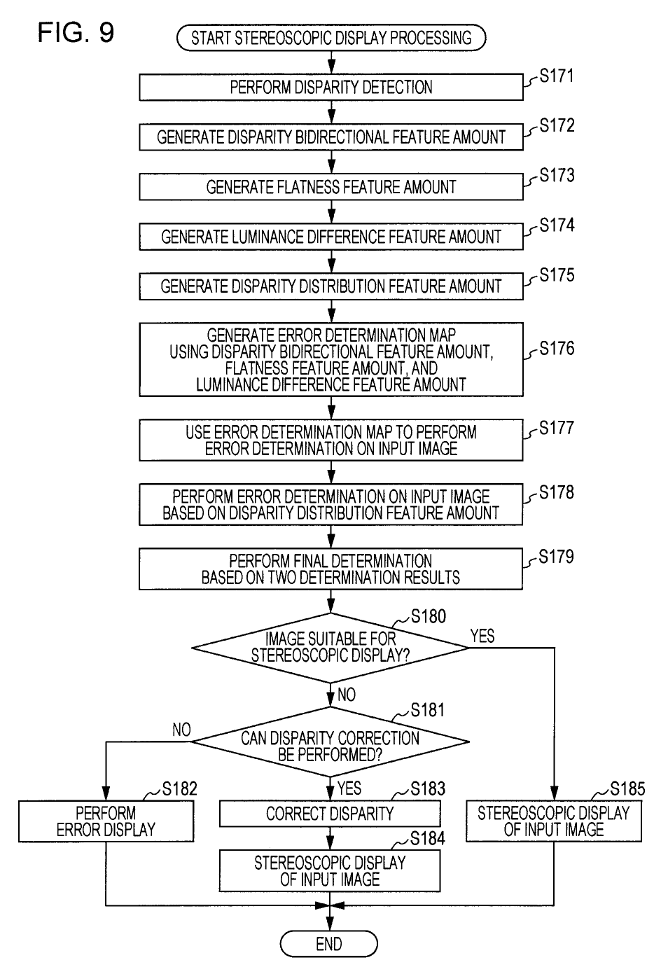

Also, in the event that determination is made that the input image is unsuitable for stereoscopic display, an arrangement may be made wherein disparity (i.e., displacement) adjustment of the input image is performed as appropriate, and stereoscopic display is performed with the input image following disparity adjustment. In such a case, the stereoscopic display processing shown in FIG. 9 is performed.

The stereoscopic display processing by the image processing device 11 will now be described with reference to the flowchart in FIG. 9. Note that the processing of step S171 through step S180 is the same as the processing in step S11 through step S20 in FIG. 2, and accordingly description thereof will be omitted.

Note however, in step S179, that in the event that determination results are supplied from the determining unit 26 to the image processing unit 27 to the effect that the image is unsuitable for stereoscopic display, the disparity distribution feature amount is also supplied along with the determination results.

In the event that determination is made in step S180 that the input image is unsuitable for stereoscopic display, in step S181 the image processing unit 27 determines whether correction of disparity (i.e., displacement) of the input image can be made, based on the disparity distribution feature amount.

For example, the image processing unit 27 determines whether or not the disparity range (i.e., displacement range) of the subject in the input image obtained by the processing in step S178 is within a disparity range in which correction can be made, and in the event that the range is within the predetermined disparity range, determination is made that the disparity can be corrected. Now, the disparity range where disparity correction (i.e., displacement correction) can be made is a range including the range of disparity suitable for stereoscopic display, used for determination in step S178.

In the event that determination is made in step S181 that the range exceeds that enabling disparity correction, in step S182 the display unit 28 performs an error display and the stereoscopic display processing ends. For example, the image processing unit 27 displays a message on the display unit 28 to the effect that stereoscopic display of the input image is not available.

Conversely, in the event that determination is made in step S181 that disparity correction can be made, in step S183 the image processing unit 27 shifts one of the input left eye input image L and right eye input image R a predetermined distance in a predetermined direction so as to correct the disparity of the input image. For example, the correction of disparity is performed such that the range of disparity of the input image following correction is within the disparity range suitable for stereoscopic display that has been determined beforehand.

In step S184, the image processing unit 27 supplies the input image of which the disparity has been corrected to the image processing display unit 28 for stereoscopic display, and the stereoscopic display processing ends.

Also, in the event that determination is made in step S180 that the input image is suitable for stereoscopic display, in step S185 the image processing unit 27 supplies the input image that has been input to the display unit 28 for stereoscopic display, and the stereoscopic display processing ends.

Thus, the image processing device 11 corrects the disparity of the input image as appropriate, and performs stereoscopic display of the input image following correction. Accordingly, an image with more suitable disparity (i.e., displacement) can be displayed, thereby alleviating tiring of the eyes of the user.

Note that while description has been made above with an example of a case where the input image is a still image, determination of whether or not the input image to be played is suitable for stereoscopic display can be performed by the same processing as the processing described above in cases where the input image is a moving image, as well.

For example, in the event that the input image is a moving image, determination regarding whether or not suitable for stereoscopic display can be made each section made up of multiple frames. That is to say, determination is made regarding each frame in a section of interest whether that frame is suitable for stereoscopic display, and in the event that a certain number or more of frames is determined to be unsuitable for stereoscopic display, that section is deemed to be unsuitable for stereoscopic display. For example, determination may be made that the entire section is unsuitable for stereoscopic display in the event that even one frame is unsuitable for stereoscopic display, or determination may be made that the overall section is unsuitable for stereoscopic display in the event that half or more of the frames are unsuitable for stereoscopic display.

Further, in the event that the input image is a moving image, an arrangement may be made wherein determination is made regarding all frames making up the moving image whether suitable for stereoscopic display, with determination regarding whether the input image is suitable for stereoscopic display or not being ultimately made based on the determination results thereof. Also, determination of whether suitable for stereoscopic display or not may be made using the first few frames of the input image.

The above-described series of processing may be carried out by hardware or may be carried out by software. In the event of carrying out the series of processing by software, a program making up the software is installed from a program recording medium to a computer built into dedicated hardware, or a general-purpose personal computer for example, capable of executing various types of functions by various types of programs being installed thereto.

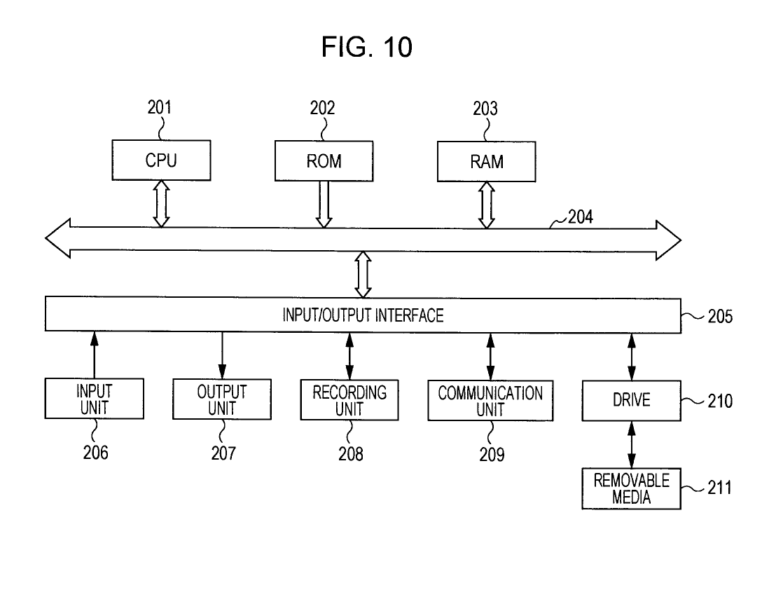

FIG. 10 is a block diagram illustrating a configuration example of hardware of a computer for executing the above-described series of processing according to a program.

With the computer, a CPU (Central Processing Unit) 201, ROM (Read Only Memory) 202, and RAM (Random Access Memory) 203, are mutually connected by a bus 204.

An input/output interface 205 is further connected to the bus 204. Connected to the input/output interface 205 are an input unit 206 made up of a keyboard, mouse, microphone, and so forth, and output unit 207 made up of a display, speaker, and so forth, a recording unit 208 made up of a hard disk, non-volatile memory, and so forth, a communication unit 209 made up of a network interface and the like, and a drive 210 for driving removable media 211 such as magnetic disks, optical discs, magneto-optical disks, semiconductor memory, and so forth.

With a computer configured as described above, the CPU 201 loads the program recorded in the recording unit 208, for example, to the RAM 203 via the input/output interface 205 and bus 204 and executes this, thereby performing the above-described series of processing.

The program which the computer (CPU 201) executes is recorded in computer-readable storage media. For example, the program can be stored in removable media 211, such as, for example, magnetic disks (including flexible disks), optical disks (CD-ROM (Compact Disc-Read Only Memory), DVD (Digital Versatile Disc) and so forth), magneto-optical disks, semiconductor memory, and so forth, which are packaged media, and provided, or is provided via cable or wireless transfer media such as a local area network, the Internet, digital satellite broadcasting, and so forth.

The program can be installed to the recording unit 208 via the input/output interface 205, by the removable media 211 being mounted to the drive 210. Also, the program can be installed in the recording unit 208 by being received with the communication unit 209 via cable or wireless transfer media. As another arrangement, the program can be installed in the ROM 202 or recording unit 208 beforehand.

Note that the program which the computer executes may be a program regarding which processing is performed following the time sequence in the order described in the present Specification, or may be a program regarding which processing is performed in parallel, or at a suitable timing, such as being called up.

Note that the embodiments of the present disclosure are not restricted to the above-described embodiments, and that various modifications may be made without departing from the essence of the present disclosure.

It should be understood by those skilled in the art that various modifications, combinations, sub-combinations and alterations may occur depending on design requirements and other factors insofar as they are within the scope of the appended claims or the equivalents thereof.

What is claimed is:

1. An apparatus for processing a stereoscopic image, comprising:
an image-reception unit receiving first and second images;
an analyzer unit determining a value of at least one parameter of the images; and
a comparison unit configured to:
compare the at least one parameter value to a threshold; and
generate a command for displaying the first and second images as a stereoscopic image, if the at least one parameter value meets the threshold.

2. The apparatus of claim 1, further comprising an image-processing unit configured to provide a command to display the first and second images as a stereoscopic image, on a display unit, based on the command.

3. The apparatus of claim 1, further comprising an image-processing unit configured to provide an alert to a user of the apparatus, if the at least one parameter value does not meet the threshold.

4. The apparatus of claim 3, further comprising an input unit for receiving input from the user, wherein the image-processing unit is further configured, if the at least one parameter value does not meet the threshold, to:
receive, via the input unit and responsive to the alert, a display instruction from the user; and
perform display processing of at least one of the first or second image, based on the display instruction.

5. The apparatus of claim 1, further comprising an image-processing unit configured to generate a command for two-dimensionally displaying one of the first and second images, if the at least one parameter value does not meet the threshold.

6. The apparatus of claim 1, further comprising an image-processing unit configured, if the at least one parameter value does not meet the threshold, to:
generate a new image combinable, with one of the first or second images, to form a stereoscopic image; and
provide a command for displaying the new image, with one of the first or second images, as a stereoscopic image.

7. The apparatus of claim 1, wherein the analyzer unit is configured to determine, as the parameter value, a disparity between a position of at least one first-image pixel of a subject in the first image and a position of a second-image pixel in the second image corresponding to the at least one pixel of the subject in the second image.

8. The apparatus of claim 7, further comprising an image-processing unit configured, if the determined disparity does not meet the threshold, to:
adjust at least one of the first or second images to change the disparity; and
provide a command for displaying the adjusted at least one of the first or second images as a stereoscopic image.

9. The apparatus of claim 1, wherein the analyzer unit is further configured to:
determine a disparity between a position of at least one first-image pixel of a subject in the first image and a position of at least one second-image pixel in the second image corresponding to the at least one first-image pixel; and
determine, as the parameter value, a reliability of the determined disparity.

10. The apparatus of claim 1, wherein the analyzer unit is configured to determine, as the parameter value, a uniformity of at least one of the first or second images.

11. The apparatus of claim 1, wherein the analyzer unit is configured to determine, as the parameter value, a difference in luminance of the first image and the second image.

12. A stereoscopic image processing method, comprising:
receiving first and second images;
determining a value of at least one parameter of the images;
comparing the at least one parameter value to a threshold; and
generating a command for displaying the first and second images as a stereoscopic image, if the at least one parameter value meets the threshold.

13. A non-transitory computer-readable storage medium storing instructions that, when executed by an image-processing device, cause the image-processing device to perform a stereoscopic image processing method, the method comprising:
receiving first and second images;
determining a value of at least one parameter of the images;
comparing the at least one parameter value to a threshold; and
generating a command for displaying the first and second images as a stereoscopic image, if the at least one parameter value meets the threshold.
